(19) United States
(12) Patent Application Publication
(10) Pub. No.: US 2019/0372415 A1
(43) Pub. Date: Dec. 5, 2019

(54) DUAL WINDING MOTOR

(71) Applicant: MANDO CORPORATION, Gyeonggi-do (KR)

(72) Inventors: Kyuyun HWANG, Gyeonggi-do (KR); Baik Kee Song, Gyeonggi-do (KR); Jae-Young Heo, Gyeonggi-do (KR)

(21) Appl. No.: 16/426,944

(22) Filed: May 30, 2019

(30) Foreign Application Priority Data
May 31, 2018 (KR) 10-2018-0062618
Sep. 5, 2018 (KR) 10-2018-0105858

(51) Int. Cl. H02K 3/28; H02K 1/14; H02K 3/18

(52) U.S. Cl. CPC H02K 3/28; H02K 2213/06; H02K 3/18; H02K 1/146

(57) ABSTRACT

Disclosed herein is a dual winding motor. The dual winding motor can be stably driven due to an asymmetric winding structure of coils and/or cores.

### CROSS-REFERENCE TO RELATED APPLICATION

Pursuant to 35 U.S.C.§ 119 (a), this application claims the benefit of earlier filing dates and rights of priorities to Korean Patent Applications No. 10-2018-0062618, filed on May 31, 2018, and 10-2018-0105858, filed on Sep. 5, 2018, the contents of which are hereby incorporated by reference in their entirety.

### BACKGROUND

### Field of Invention

The present disclosure relates to a dual winding motor.

### Discussion of Related Art

Generally, a motor is composed of a stator with a coil which is wound therearound, and a rotor accommodated in the stator and configured to be rotated due to a magnetic force which is generated from the coil of the stator. In order to improve driving reliability of the motor, research on a dual winding motor is being conducted.

The term “dual winding motor” means a motor which is composed of two or more power sources and, even when a failure or damage occurs in a wire wound around the motor which is connected to any one of the two or more power sources, the motor can be driven by only the remaining power sources.

FIG. 1 is a cross-sectional view of the conventional dual winding motor. The conventional dual winding motor is composed of a stator 10 and a rotor 12 accommodated in the stator 10 and configured to be rotated. Further, the stator 10 is composed of a core 11, in which the rotor 12 is accommodated, and a plurality of winding poles 15 protruding from an inner circumferential surface of the core 11 toward the rotor 12.

Each of the plurality of winding poles 15 is formed at a predetermined interval such that a winding slot 30 is formed between a pair of adjacent winding poles 15, and a coil 14 is wound around each of the plurality of winding poles 15.

Here, in the conventional dual winding motor, the coils 14 wound around the plurality of winding poles 15 have the same winding structure. That is, the coils 14 have the same diameter and the same number of turns.

Consequently, a pair of coils accommodated in the winding slot 30 formed by the pair of adjacent winding poles 15 are formed symmetrically.

Such a dual winding motor has two divided windings configured to supply three-phase power. When a failure occurs in one of the two divided windings, the dual winding motor is driven by the other winding. However, since the same current is applied to the two divided windings when the dual winding motor is driven, the two divided windings also generate the same heat.

That is, assuming that a dielectric breakdown of a coil occurs due to overload, coils of the two divided windings are simultaneously damaged such that only one of the two divided windings cannot be driven such that there is a problem in that redundancy is difficult to implement.

Further, when a failure occurs in one of two inverters connected to the dual winding motor due to a heat generation problem, the dual winding motor can be driven by the other inverter. However, since an amount of a current is twice an amount of a usual current, there is a problem in that normal operation of the dual winding motor is barely possible.

### SUMMARY OF THE INVENTION

The present disclosure is directed to a dual winding motor which is capable of differentiating heating amounts of dual windings due to an asymmetric winding structure of a coil.

The present disclosure is also directed to a dual winding motor which is capable of differentiating heating amounts of dual windings and simultaneously stably driving the dual windings with a single inverter due to an asymmetric winding and an asymmetric core structure.

In order to achieve at least the above objects, in whole or in part, and in accordance with the purposes of the present disclosure, as embodied and broadly described, and in one general aspect, there may be provided a dual winding motor comprising: a stator; and a rotor accommodated in the stator and configured to be rotated by the stator, wherein the stator may include a core configured to accommodate the rotor in a central portion thereof; a plurality of winding poles configured to protrude from the core toward the rotor and around which coils are wound; a plurality of first coils wound around some of the plurality of winding poles and configured to constitute a first winding part through which a three-phase current flows; and a plurality of second coils wound around the remaining poles among the plurality of winding poles and configured to constitute a redundancy part of the first winding part, wherein the first coil may be asymmetrical with the second coil.

In some exemplary embodiment of the present invention, the number of turns of the second coil may be larger than that of the first coil.

In some exemplary embodiment of the present invention, the number of turns of the second coil may be substantially twice that of the first coil.

In some exemplary embodiment of the present invention, a diameter of the second coil may be smaller than that of the first coil.

In some exemplary embodiment of the present invention, a diameter of the second coil may be smaller than that of the first coil; and the number of turns of the second coil may be larger than that of the first coil.

In some exemplary embodiment of the present invention, a diameter of the second coil may be smaller than that of the first coil; and the number of turns of the second coil may be smaller than that of the first coil.

In some exemplary embodiment of the present invention, a magnitude of a current supplied to the first coil may be different from that of a current supplied to the second coil.

In another general aspect of the present invention, there may be provided a dual winding motor comprising: a stator; and a rotor accommodated in the stator and configured to be rotated by the stator, wherein the stator includes: a core configured to accommodate the rotor in a central portion thereof; a plurality of winding poles configured to protrude from the core toward the rotor and around which coils are wound; a plurality of first coils wound around a plurality of first winding poles which are some of the plurality of winding poles and configured to constitute a first winding part through which a three-phase current flows; and a plurality of second coils wound around a plurality of second winding poles which are the remaining poles among the plurality of winding poles and configured to constitute a redundancy part of the first winding part, wherein the first winding pole may be asymmetrical with the second winding pole.

In some exemplary embodiment of the present invention, a length of the first winding pole may be smaller than the of the second winding pole.

In some exemplary embodiment of the present invention, the first winding pole and the second winding pole may be alternately disposed.

In some exemplary embodiment of the present invention, the first winding pole may be disposed at one side of the core, and the second winding pole may be disposed at the other side of the core.

In some exemplary embodiment of the present invention, some of the plurality of first winding poles and some of the plurality of second winding poles may be alternately disposed.

In some exemplary embodiment of the present invention, the number of turns of the second coil may be larger than that of the first coil.

In some exemplary embodiment of the present invention, the number of turns of the second coil may be substantially twice that of the first coil. In some exemplary embodiment of the present invention, a magnitude of a current supplied to the first coil may be different from that of a current supplied to the second coil.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a cross-sectional view of a conventional dual winding motor;

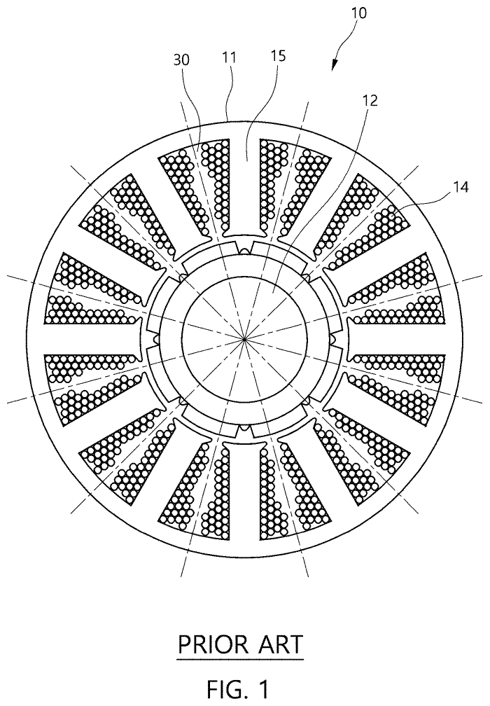

FIG. 2 is a cross-sectional view of a dual winding motor according to a first embodiment of the present disclosure;

FIG. 3 is an equivalent circuit diagram of the dual winding motor of FIG. 2;

FIG. 4 is a cross-sectional view of a dual winding motor according to a second embodiment of the present disclosure;

FIG. 5 is an equivalent circuit diagram of the dual winding motor of FIG. 4;

FIG. 6 is a cross-sectional view of a dual winding motor according to a third embodiment of the present disclosure;

FIG. 7 is an equivalent circuit diagram of the dual winding motor of FIG. 6;

FIG. 8 is a cross-sectional view of a dual winding motor according to a fourth embodiment of the present disclosure;

FIG. 9 is an equivalent circuit diagram of the dual winding motor of FIG. 8;

FIG. 10 is a cross-sectional view of a dual winding motor according to a fifth embodiment of the present disclosure;

FIG. 11 is an equivalent circuit diagram of the dual winding motor of FIG. 10;

FIG. 12 is a cross-sectional view of a dual winding motor according to a sixth embodiment of the present disclosure; and

FIG. 13 is an equivalent circuit diagram of the dual winding motor of FIG. 12.

### DETAILED DESCRIPTION OF EXEMPLARY EMBODIMENTS

The present disclosure may be applied with various changes and may be included with various exemplary embodiments, and particular exemplary embodiments will be exemplified by drawings and explained in the Detailed Description. However, the present disclosure will not be limited to the particular exemplary embodiments, and the described aspect is intended to embrace all such alterations, modifications, and variations that fall within the scope and novel idea of the present disclosure.

Accordingly, in some embodiments, well-known processes, well-known device structures and well-known techniques are not illustrated in detail to avoid unclear interpretation of the present disclosure.

Hereinafter, exemplary embodiments of the present disclosure will be described in detail with reference to the accompanying drawings.

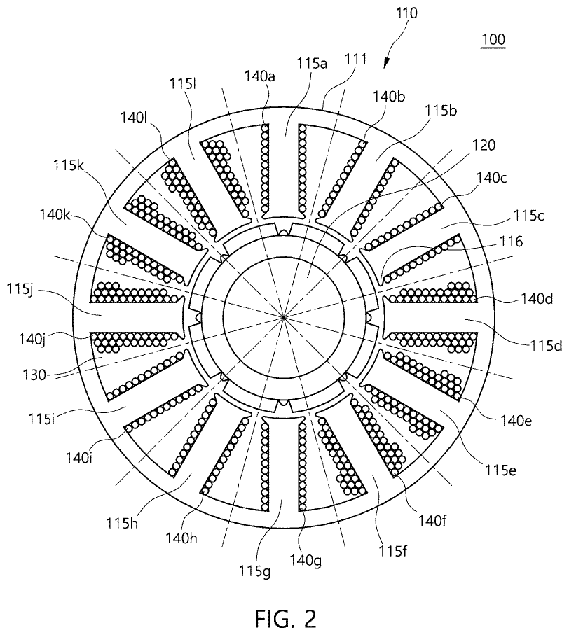

FIG. 2 is a cross-sectional view of a dual winding motor according to a first embodiment of the present disclosure.

As shown in the drawing, a dual winding motor 100 according to the first embodiment of the present disclosure includes a stator 110 and a rotor 120 accommodated in the stator 110 and configured to be rotated due to a magnetic force generated from the stator 110.

The stator 110 may include a core 111 having a circular or polygonal shape, and a plurality of winding poles 115a to 115l protruding from the core 111 to the rotor 120. In this case, the core 111 and the plurality of winding poles 115a to 115l may be integrally formed. The plurality of winding poles 115a to 115l may be formed at predetermined intervals along an inner circumferential surface of the core 111.

When a direction from the core 111 to the rotor 120 is referred to as a longitudinal direction and a direction perpendicular to the longitudinal direction is referred to as a lateral direction, all widths of the plurality of winding poles 115a to 115l in the lateral direction may be formed to be uniform.

Further, winding protrusions 116 protruding in the lateral direction of each of the plurality of winding poles 115a to 115l may be formed at an end portion of each of the plurality of winding poles 115a to 115l.

Since the plurality of winding poles 115 are formed at predetermined intervals, a winding slot 130 in which a coil 140a to 140l is accommodated may be formed between adjacent winding poles 115a to 115l. The number of the winding slots 130 is equal to that of the plurality of winding poles 115a to 115l. An opening may be formed at one side of the winding slot 130 adjacent to the end portion of each of the plurality of winding poles 115a to 115l.

Since the width of each of the plurality of winding poles 115a to 115l in the lateral direction is constant and the core 111 is formed in a circular or polygonal shape, a lateral width of the winding slot 130 may be formed to decrease in a direction from the core 111 to the opening.

Since the winding protrusions 116 formed at the end portion of each of the plurality of winding poles 115a to 115l protrude in the lateral direction of each of the plurality of winding poles 115a to 115l, the opening of the winding slot 130 abruptly becomes narrower at the end portion of each of the plurality of the winding pole 115a to 115l. Consequently, it is possible to prevent the coil 140 accommodated in the winding slot 130 from being released to the outside.

In one embodiment of the present disclosure, twelve winding poles 115a to 115l have been described as being formed, but the present disclosure is not limited thereto, and a greater or fewer number of winding poles 115a to 115l may be formed according to a characteristic of the dual winding motor 100.

In one embodiment of the present disclosure, twelve winding poles 115a to 115l will be referred to as first to twelfth winding poles 115a to 115l, respectively. The coils 140 wound around the first to twelfth winding poles 115a to 115l will be referred as first to twelfth coils 140a to 140l.

The first coil 140a and the seventh coil 140g opposite to the first coil 140a are connected in series or in parallel such that an A-phase current of the motor 100 may flow in the first coil 140a and the seventh coil 140g, and the second coil 140b and the eighth coil 140h opposite to the second coil 140b are connected in series or in parallel such that a B-phase current of the motor 100 may flow in the second coil 140b and the eighth coil 140h. Similarly, the third coil 140c and the ninth coil 140i opposite to the third coil 140c are connected in series or in parallel such that a C-phase current of the motor 100 may flow in the third coil 140c and the ninth coil 140i.

As described above, the first coil 140a, the seventh coil 140g, the second coil 140b, the eighth coil 140h, the third coil 140c, and the ninth coil 140i may constitute a first winding part.

However, in one embodiment of the present disclosure, two coils in which a single-phase current flow have been described as being formed, but the present disclosure is not limited thereto, and a greater or fewer number of coils may be connected according to a characteristic of the motor 100. Therefore, the number of winding poles may also be varied.

Further, the first coil 140a has been described as being connected to the seventh coil 140g opposite to the first coil 140a such that the A-phase current flows, but the first coil 140a may be connected to the fourth coil 140d. In this case, the second coil 140b may be connected to the fifth coil 140e, and the third coil 140c may be connected to the sixth coil 140f. That is, a method of connecting coils may be variously determined according to a configuration of the motor 100.

Meanwhile, the fourth coil 140d and the tenth coil 140j opposite to the fourth coil 140d may be connected in series or in parallel such that an A′-phase current of the motor 100 may flow in the fourth coil 140d and the tenth coil 140j. In this case, the A′-phase current may serve as redundancy of the A-phase current. The fifth coil 140e and the eleventh coil 140k opposite to the fifth coil 140e may be connected in series or in parallel such that a B′-phase current of the motor 100 may flow in the fifth coil 140e and the eleventh coil 140k. Further, the sixth coil 140f and the twelfth coil 140l opposite to the sixth coil 140f may be connected in series or in parallel such that a C′-phase current of the motor 100 may flow in the sixth coil 140f and the twelfth coil 140l. Similarly, the B′-phase current may serve as redundancy of the B phase current, and the C′-phase current may serve as redundancy of the C-phase current.

As described above, the fourth coil 140d, the tenth coil 140j, the fifth coil 140e, the eleventh coil 140k, the sixth coil 140f, and the twelfth coil 140l may constitute a second winding part.

In one embodiment of the present disclosure, the fact that two coils are connected in series means that an input of one coil is connected to an output of the other coil. Further, the fact that two coils are connected in parallel means that an input of one coil is connected to an input of the other coil.

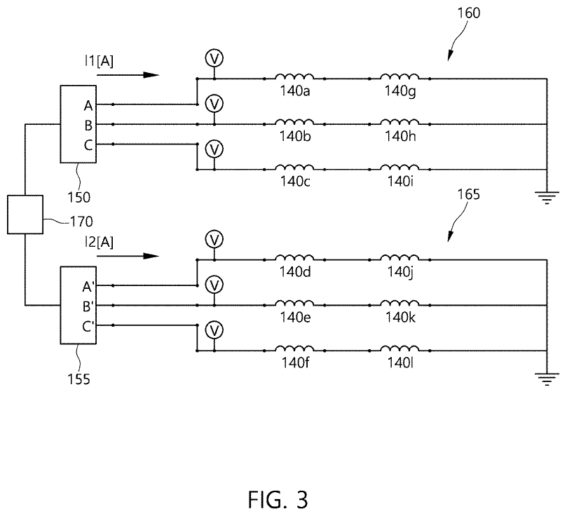

FIG. 3 is an equivalent circuit diagram of the dual winding motor of FIG. 2 for describing a case in which two coils of FIG. 2 are connected in series.

As shown in the drawing, a first winding part 160 may output a three-phase voltage using a current supplied from a first inverter 150 due to a serial connection between the first coil 140a and the seventh coil 140g, a serial connection between the second coil 140b and the eighth coil 140h, and a serial connection between the third coil 140c and the ninth coil 140i.

Further, a second winding part 165 which serves as redundancy of the first winding part 160 may output a three-phase voltage using a current supplied from a second inverter 155 due to a serial connection between the fourth coil 140d and the tenth coil 140j, a serial connection between the fifth coil 140e and the eleventh coil 140k, and a serial connection between the sixth coil 140f and the twelfth coil 140l.

In this case, since specific operations of the inverters 150 and 155 are irrelevant to an example of the present disclosure, descriptions thereof will be omitted.

Referring again to FIG. 2, the dual winding motor 100 of the first embodiment of the present disclosure is characterized in that the number of turns of the coils constituting the first winding part 160 is asymmetrical with the number of turns of the coils constituting the second winding part 165.

A heating value of the coil 140 wound around the winding pole 115 is inversely proportional to a diameter of the coil 140 and is proportional to the number of turns thereof. That is, when the diameter of the coil 140 decreases, the heating value increases, and when the number of turns of the coil 140 becomes larger, the heating value becomes larger. On the other hand, when the diameter of the coil 140 increases, the heating value decreases, and when the number of turns of the coil 140 decreases, the heating value decreases.

That is, in the dual winding motor 100 of the first embodiment of the present disclosure, the number of turns of the coils (the first coil 140a, the seventh coil 140g, the second coil 140b, the eighth coil 140h, the third coil 140c, and the ninth coil 140i) of the first winding part 160 may be formed to be smaller than the number of turns of the coils (the fourth coil 140d, the tenth coil 140j, the fifth coil 140e, the eleventh coil 140k, the sixth coil 140f, and the twelfth coil 140l) of the second winding part 165.

That is, when compared with a conventional case in which the number of turns of the coils of the first winding part 160 is equal to the number of turns of the coils of the second winding part 165, in the first embodiment of the present disclosure, the number of turns of the coils of the first winding part 160 may be smaller than the number of turns of the coils of the second winding part 165. However, since the above description is merely an example, the number of turns of the coils of the first winding part 160 may be larger than the number of turns of the coils of the second winding part 165.

With the above-described configuration, when a three-phase alternating current (AC) is supplied to the motor 100 of the first embodiment of the present disclosure, a heating value of the second winding part 165 becomes larger than that of the first winding part 160, and when overload occurs, dielectric breakdown occurs in the coils of the second winding part 165 prior to those of the first winding part 160 such that the motor 100 is driven through the coils of the first winding part 160.

In a conventional case, when the overload occurs, the first and second winding parts of the dual winding motor have the same heating value such that dielectric breakdown occurs simultaneously in all the coils of the first and second winding parts such that the dual winding motor cannot be driven. However, according to the present disclosure, the above-described situation may be prevented.

As described above, when the coils of the first winding part 160 are asymmetrical with those of the second winding part 165, a magnetic imbalance may occur. However, such a magnetic imbalance may be solved by applying an asymmetric current. That is, when magnitudes of the currents supplied from the first and second inverters 150 and 155 are made to be different, the magnetic imbalance may be solved.

Specifically, since the magnetic balance is determined by the product of the number of turns and a current (N×I), when the number of turns is varied, a magnitude of the current is varied such that the magnetic balance may be maintained. The magnetic balance will be described below.

That is, a controller 170 may control the first and second inverters 150 and 155 to provide asymmetric currents to the first and second winding parts 160 and 165.

Meanwhile, in the first embodiment of the present disclosure, the number of turns of the coils of the second winding part 165 may be twice the number of turns of the coils of the first winding part 160.

As in the conventional case, when the number of turns of the coils of the first winding part is equal to the number of turns of the coils of the second winding part and a failure occurs in one inverter due to heat generation, even though the other inverter can drive the motor, the other inverter should output a current that is twice a usual current such that normal operation is impossible due to the heat generation.

However, as in the first embodiment of the present disclosure, when the number of turns of the coils of the second winding part 165 is twice the number of turns of the coils of the first winding part 160, the controller 170 may control the second inverter 155, in normal operation, to allow the second winding part 165 to output a current that is half of a current of the first winding part 160. Even in a case in which a failure occurs in the first winding part 160 such as to not be driven, the controller 170 may control the second inverter 155 to allow the second winding part 165 to output a current that is the same as a usual current output to the first winding part 160.

Consequently, since the motor 100 may maintain the same torque as in the normal operation even when the second inverter 155 outputs the same current as usual, it is possible to drive the motor 100 as stably and consistently as when driving the motor 100 through the first and second windings 160 and 165.

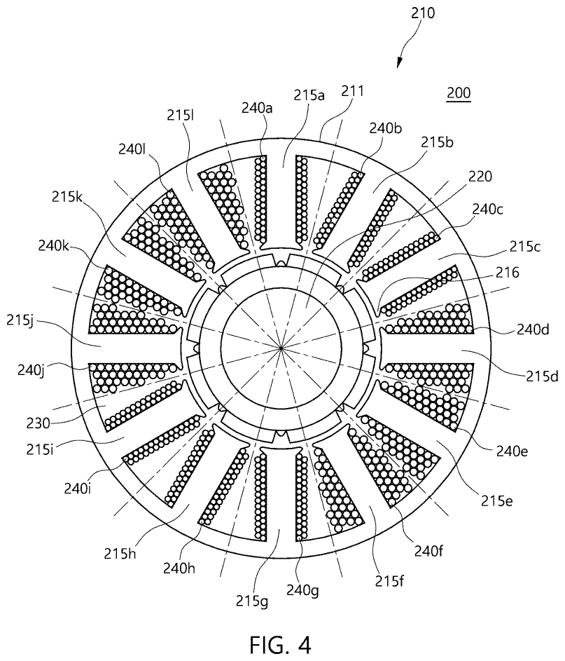

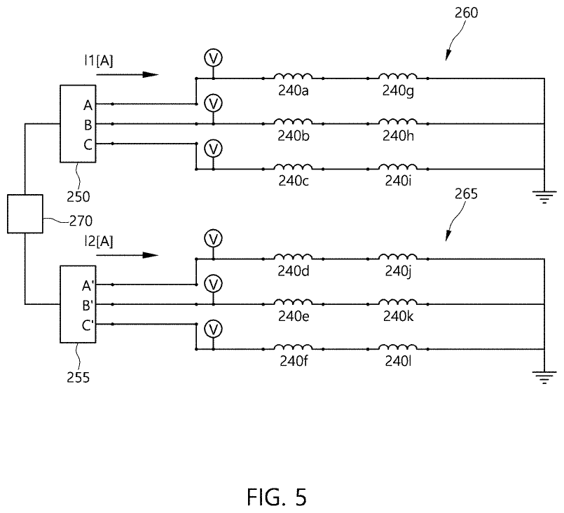

FIG. 4 is a cross-sectional view of a dual winding motor according to a second embodiment of the present disclosure, and FIG. 5 is an equivalent circuit diagram of the dual winding motor of FIG. 4 in a case in which coils are connected in series.

As shown in the drawings, a dual winding motor 200 of the second embodiment of the present disclosure may include a stator 210 and a rotor 220 accommodated in the stator 210 and configured to be rotated due to a magnetic force generated from the stator 210. A shape of a winding pole 215, a shape of a winding protrusion 216, and a description of the winding slot 230 are the same as those of the winding pole, the winding protrusion, and the winding slot described in the first embodiment, and thus detailed descriptions thereof will be omitted.

Referring to FIGS. 4 and 5, a first winding part 260 may output a three-phase voltage using a current supplied from a first inverter 250 due to a serial connection between a first coil 240a and a seventh coil 240g, a serial connection between a second coil 240b and an eighth coil 240h, and a serial connection between a third coil 240c and a ninth coil 240i.

Further, a second winding part 265 which serves as redundancy of the first winding part 260 may output a three-phase voltage using a current supplied from a second inverter 255 due to a serial connection between a fourth coil 240d and a tenth coil 240j, a serial connection between a fifth coil 240e and an eleventh coil 240k, and a serial connection between a sixth coil 240f and a twelfth coil 240l.

In the dual winding motor 200 of the second embodiment of the present disclosure, a diameter of each of the coils of the first winding part 260 may be asymmetrical with that of each of the coils of the second winding part 265 to be configured to be smaller than that of each of the coils of the second winding part 265. However, since the above description is merely an example, the diameter of each of the coils of the first winding part 260 may be configured to be larger than that of each of the coils of the second winding part 265.

That is, a controller 270 may control the first and second inverters 250 and 255 to provide asymmetric currents to the first and second winding parts 260 and 265.

With the above-described configuration, when a three-phase alternating current (AC) is supplied to the motor 200 of the second embodiment of the present disclosure, a heating value of the first winding part 260 becomes larger than that of the second winding part 265, and when overload occurs, dielectric breakdown occurs in the coils of the first winding part 260 prior to those of the second winding part 265 such that the motor 200 is driven through the coils of the second winding part 265.

In a conventional case, when the overload occurs, the first and second winding parts of the dual winding motor have the same heating value such that dielectric breakdown occurs simultaneously in all the coils of the first and second winding parts such that the dual winding motor cannot be driven. However, according to the present disclosure, the above-described situation may be prevented.

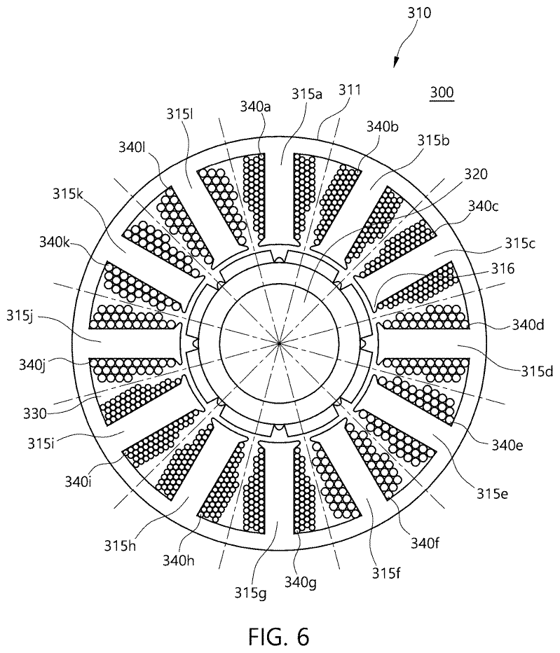

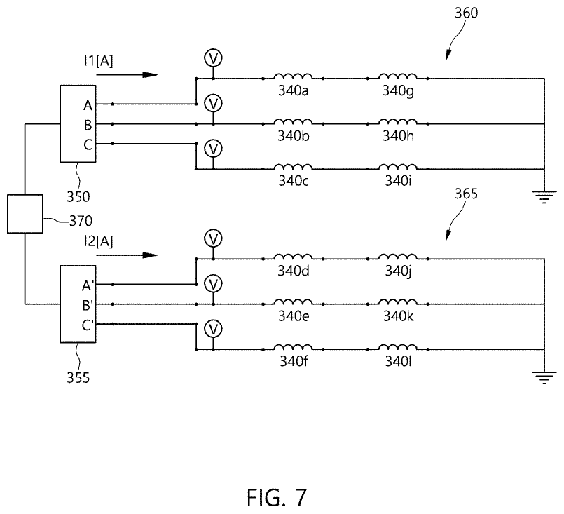

FIG. 6 is a cross-sectional view of a dual winding motor according to a third embodiment of the present disclosure, and FIG. 7 is an equivalent circuit diagram of the dual winding motor of FIG. 6 in a case in which coils are connected in series.

As shown in the drawings, a dual winding motor 300 of the second embodiment of the present disclosure may include a stator 310 and a rotor 320 accommodated in the stator 310 and configured to be rotated due to a magnetic force generated from the stator 310. A shape of a winding pole 315a to 315l, a shape of a winding protrusion 316, and a description of the winding slot 330 are the same as those of the winding pole, the winding protrusion, and the winding slot described in the first embodiment, and thus detailed descriptions thereof will be omitted.

Referring to FIGS. 6 and 7, a first winding part 360 may output a three-phase voltage using a current supplied from a first inverter 350 due to a serial connection between a first coil 340a and a seventh coil 340g, a serial connection between a second coil 340b and an eighth coil 340h, and a serial connection between a third coil 340c and a ninth coil 340i.

Further, a second winding part 365 which serves as redundancy of the first winding part 360 may output a three-phase voltage using a current supplied from a second inverter 355 due to a serial connection between a fourth coil 340d and a tenth coil 340j, a serial connection between a fifth coil 340e and an eleventh coil 340k, and a serial connection between a sixth coil 340f and a twelfth coil 340l.

In the dual winding motor 300 of the third embodiment of the present disclosure, a diameter of each of the coils of the first winding part 360 and the number of turns thereof may be asymmetrical with those of each of the coils of the second winding part 365. For example, the diameter of each of the coils of the first winding part 360 may be smaller than that of each of the coils of the second winding part 365, and the number of turns of the coils of the first winding part 360 may be larger than the number of turns of the coils of the second winding part 365.

However, the above description is merely an example. The diameter of each of the coils of the first winding part 360 may be larger than that of each of the coils of the second winding part 365, and the number of turns of the coils of the first winding part 360 may be larger than the number of turns of the coils of the second winding part 365. Alternatively, the diameter of each of the coils of the first winding part 360 may be smaller than that of each of the coils of the second winding part 365, and the number of turns of the coils of the first winding part 360 may be smaller than the number of turns of the coils of the second winding part 365. Also alternatively, the diameter of each of the coils of the first winding part 360 may be larger than that of each of the coils of the second winding part 365, and the number of turns of the coils of the first winding part 360 may be smaller than the number of turns of the coils of the second winding part 365.

That is, a controller 370 may control the first and second inverters 350 and 355 to provide asymmetric currents to the first and second winding parts 360 and 365.

With the above-described configuration, when a three-phase AC is supplied to the motor 300 of the third embodiment of the present disclosure, a heating value of the first winding part 360 becomes larger than that of the second winding part 365, and when overload occurs, dielectric breakdown occurs in the coils of the first winding part 360 prior to those of the second winding part 365 such that the motor 300 is driven through the coils of the second winding part 365.

In a conventional case, when the overload occurs, the first and second winding parts of the dual winding motor have the same heating value such that dielectric breakdown occurs simultaneously in all the coils of the first and second winding parts such that the dual winding motor cannot be driven. However, according to the present disclosure, the above-described situation may be prevented.

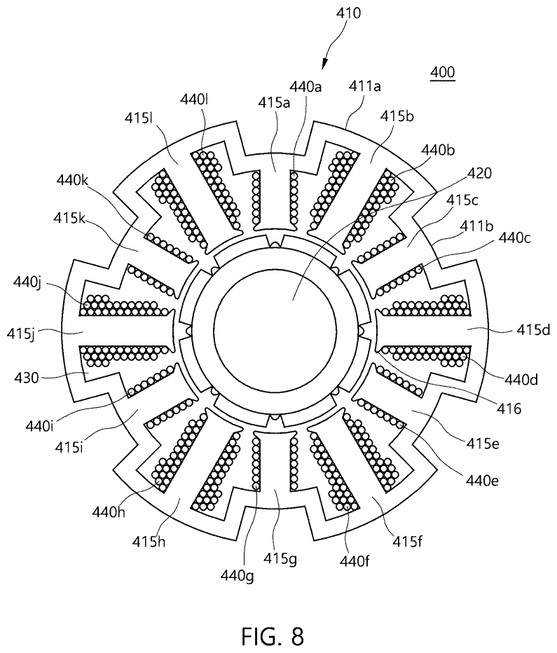

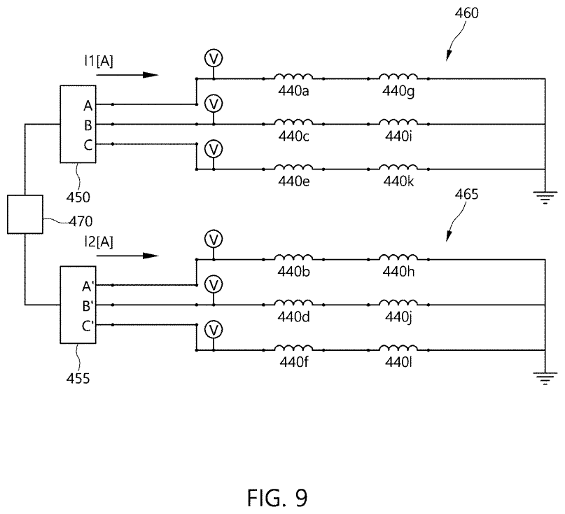

FIG. 8 is a cross-sectional view of a dual winding motor according to a fourth embodiment of the present disclosure, and FIG. 9 is an equivalent circuit diagram of the dual winding motor of FIG. 8 in a case in which coils are connected in series.

As shown in the drawing, a dual winding motor 400 according to the fourth embodiment of the present disclosure includes a stator 410 and a rotor 420 accommodated in the stator 410 and configured to be rotated due to a magnetic force generated from the stator 410.

In the fourth embodiment of the present disclosure, a shape of the stator 410 may be asymmetrical. That is, lengths of first, third, fifth, seventh, ninth and eleventh winding poles 415a, 415c, 415e, 415g, 415i, and 415k are smaller than those of second, fourth, sixth, eighth, tenth, and twelfth winding poles 415b, 415d, 415f, 415h, 415j, and 415l.

In this case, winding protrusions 416 of each of the first to twelfth winding poles 415a to 415l are formed at predetermined intervals to form a substantially circular shape. Consequently, a shape of a core 411 which is a circumferential surface of the stator 410 may be configured such that a plurality of protrusions 411a and a plurality of concave portions 411b are alternately disposed.

First to twelfth coils 440a to 440l may be wound around the first to twelfth winding poles 415a to 415l.

The first coil 440a and the seventh coil 440g opposite to the first coil 140a are connected in series or in parallel such that an A-phase current of the motor 400 may flow in the first coil 440a and the seventh coil 440g, and the third coil 440c and the ninth coil 440i opposite to the third coil 440c are connected in series or in parallel such that a B-phase current of the motor 400 may flow in the third coil 440c and the ninth coil 440i. Similarly, the fifth coil 440e and the eleventh coil 440k opposite to the fifth coil 440e are connected in series or in parallel such that a C-phase current of the motor 400 may flow in the fifth coil 440e and the eleventh coil 440k.

As described above, the first coil 440a, the seventh coil 440g, the third coil 440c, the ninth coil 440i, the fifth coil 440e, and the eleventh coil 440k may constitute the first winding part 460.

Meanwhile, the second coil 440b and the eighth coil 440h opposite to the second coil 440b may be connected in series or in parallel such that an A′-phase current of the motor 400 may flow in the second coil 440b and the eighth coil 440h. In this case, the A′-phase current may serve as redundancy of the A-phase current. The fourth coil 440d and the tenth coil 440j opposite to the fourth coil 440d may be connected in series or in parallel such that a B′-phase current of the motor 400 may flow in the fourth coil 440d and the tenth coil 440j. Further, the sixth coil 440f and the twelfth coil 440l opposite to the sixth coil 140f may be connected in series or in parallel such that a C′-phase current of the motor 400 may flow in the sixth coil 140f and the twelfth coil 140l. Similarly, the B′-phase current may serve as redundancy of the B phase current, and the C′-phase current may serve as redundancy of the C-phase current.

As described above, the second coil 440b, the eighth coil 440h, the fourth coil 440d, the tenth coil 440j, the sixth coil 440f, and the twelfth coil 440l may constitute the second winding part 465.

In the dual winding motor 400 having such a structure, the first winding part 460 may output a three-phase voltage using a current supplied from a first inverter 450 due to a serial connection between a first coil 440a and a seventh coil 440g, a serial connection between a third coil 440c and a ninth coil 440i, and a serial connection between a fifth coil 440e and an eleventh coil 440k.

Further, a second winding part 465 which serves as redundancy of the first winding part 460 may output a three-phase voltage using a current supplied from a second inverter 455 due to a serial connection between a second coil 440b and an eighth coil 440h, a serial connection between a fourth coil 440d and a tenth coil 440j, and a serial connection between a sixth coil 440f and a twelfth coil 440l

In this case, the number of turns of the coils of the second winding part 465 may be twice the number of turns of the coils of the first winding part 460.

As in the conventional case, when the number of turns of the coils of the first winding part is equal to the number of turns of the coils of the second winding part and a failure occurs in one inverter due to heat generation, even though the other inverter can drive the motor, the other inverter should output a current that is twice a usual current such that normal operation is impossible due to the heat generation. However, as in the fourth embodiment of the present disclosure, when the number of turns of the coils of the second winding part 465 is twice the number of turns of the coils of the first winding part 460, the controller 470 may control the second inverter 455, in normal operation, to allow the second winding part 465 to output a current that is half of a current of the first winding part 460. Even in a case in which a failure occurs in the first winding part 460 such as to not be driven, the controller 470 may control the second inverter 455 to allow the second winding part 465 to output a current that is the same as a usual current output to the first winding part 460.

Consequently, since the motor 400 may maintain the same torque as in the normal operation even when the second inverter 455 outputs the same current as usual, it is possible to drive the motor 400 as stably and consistently as when driving the motor 400 through the first and second windings 460 and 465.

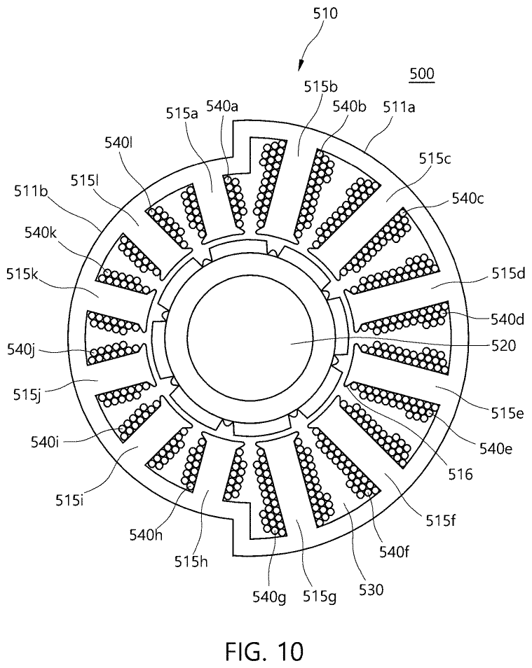

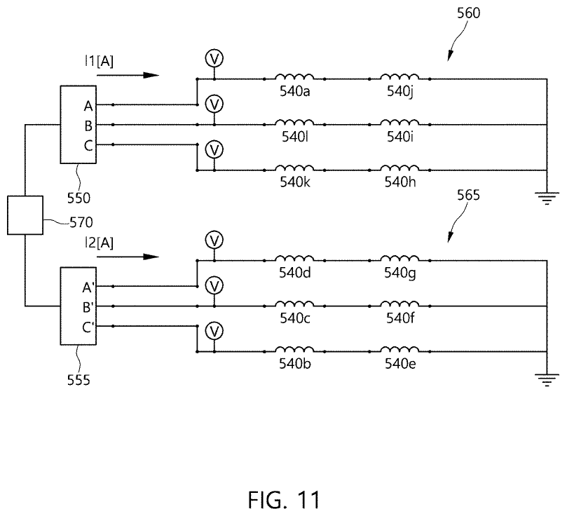

FIG. 10 is a cross-sectional view of a dual winding motor according to a fifth embodiment of the present disclosure, and FIG. 11 is an equivalent circuit diagram of the dual winding motor of FIG. 10 in a case in which coils are connected in series.

As shown in the drawing, a dual winding motor 500 according to the fifth embodiment of the present disclosure includes a stator 510 and a rotor 520 accommodated in the stator 510 and configured to be rotated due to a magnetic force generated from the stator 510.

In the fifth embodiment of the present disclosure, a shape of the stator 510 may be asymmetrical. That is, lengths of first, eighth, ninth, tenth, eleventh, and twelfth winding poles 515a, 515h, 515i, 515j, 515k, and 515l are smaller than those of second, third, fourth, fifth, sixth, and seventh winding poles 515b, 515c, 515d, 515e, 515f, and 515g.

In this case, winding protrusions 516 of each of the first to twelfth winding poles 515a to 515l are formed at predetermined intervals to form a substantially circular shape. Consequently, a shape of a core 511 which is a circumferential surface of the stator 510 may be configured with a protrusion 511a and a concave portion 511b. In this case, the second, third, fourth, fifth, sixth, and seventh winding poles 515b, 515c, 515d, 515e, 515f, and 515g are disposed inside the protrusion 511a, and the first, eighth, ninth, tenth, eleventh, and twelfth winding poles 515a, 515h, 515i, 515j, 515k, and 515l may be disposed on an inner surface of the concave portion 511b.

First to twelfth coils 540a to 540l may be wound around the first to twelfth winding poles 515a to 515l.

In the fifth embodiment of the present disclosure, the first coil 540a and the tenth coil 540j opposite to the first coil 540a are connected in series or in parallel such that an A-phase current of the motor 500 may flow in the first coil 540a and the tenth coil 540j, and the twelfth coil 540l and the ninth coil 540i opposite to the twelfth coil 540l are connected in series or in parallel such that a B-phase current of the motor 500 may flow in the twelfth coil 540l and the ninth coil 540i. Similarly, the eleventh coil 540k and the eighth coil 540h opposite to the eleventh coil 540k are connected in series or in parallel such that a C-phase current of the motor 500 may flow in the eleventh coil 540k and the eighth coil 540h.

As described above, the first coil 540a, the tenth coil 540j, the twelfth coil 540l, the ninth coil 540i, the eleventh coil 540k, and the eighth coil 540h may constitute the first winding part 560.

Meanwhile, the fourth coil 540d and the seventh coil 540g opposite to the fourth coil 540d may be connected in series or in parallel such that an A′-phase current of the motor 500 may flow in the fourth coil 540d and the seventh coil 540g. In this case, the A′-phase current may serve as redundancy of the A-phase current. The third coil 540c and the sixth coil 540f opposite to the third coil 540c may be connected in series or in parallel such that a B′-phase current of the motor 500 may flow in the third coil 540c and the sixth coil 540f. Further, the second coil 540b and the fifth coil 540e opposite to the second coil 540b may be connected in series or in parallel such that a C′-phase current of the motor 500 may flow in the second coil 540b and the fifth coil 540e. Similarly, the B′-phase current may serve as redundancy of the B phase current, and the C′-phase current may serve as redundancy of the C-phase current.

As described above, the fourth coil 540d, the seventh coil 540g, the third coil 540c, the sixth coil 540f, the second coil 540b, and the fifth coil 540e may constitute the second winding part 565.

In the dual winding motor 500 having such a structure, the first winding part 560 may output a three-phase voltage using a current supplied from a first inverter 550 due to a serial connection between the first coil 540a and the tenth coil 540j, a serial connection between the twelfth coil 540l and the ninth coil 540i, and a serial connection between the eleventh coil 540k and the eighth coil 540h.

Further, a second winding part 565 which serves as redundancy of the first winding part 560 may output a three-phase voltage using a current supplied from a second inverter 555 due to a serial connection between the fourth coil 540d and the seventh coil 540g, a serial connection between the third coil 540c and the sixth coil 540f, and a serial connection between the second coil 540b and the fifth coil 540e.

In this case, the number of turns of the coils of the second winding part 565 may be twice the number of turns of the coils of the first winding part 560.

As in the conventional case, when the number of turns of the coils of the first winding part is equal to the number of turns of the coils of the second winding part and a failure occurs in one inverter due to heat generation, even though the other inverter can drive the motor, the other inverter should output a current that is twice a usual current such that normal operation is impossible due to the heat generation.

However, as in the fifth embodiment of the present disclosure, when the number of turns of the coils of the second winding part 565 is twice the number of turns of the coils of the first winding part 560, the controller 570 may control the second inverter 555, in normal operation, to allow the second winding part 565 to output a current that is half of a current of the first winding part 560. Even in a case in which a failure occurs in the first winding part 560 such as to not be driven, the controller 570 may control the second inverter 555 to allow the second winding part 565 to output a current that is the same as a usual current output to the first winding part 560.

Consequently, since the motor 500 may maintain the same torque as in the normal operation even when the second inverter 555 outputs the same current as usual, it is possible to drive the motor 500 as stably and consistently as when driving the motor 500 through the first and second windings 560 and 565.

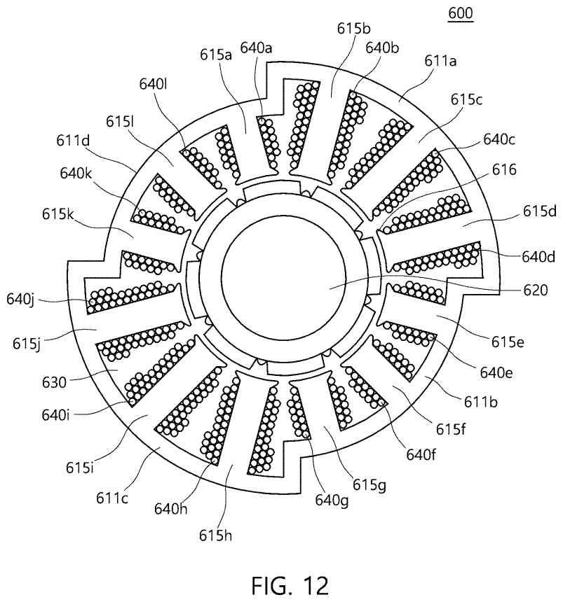

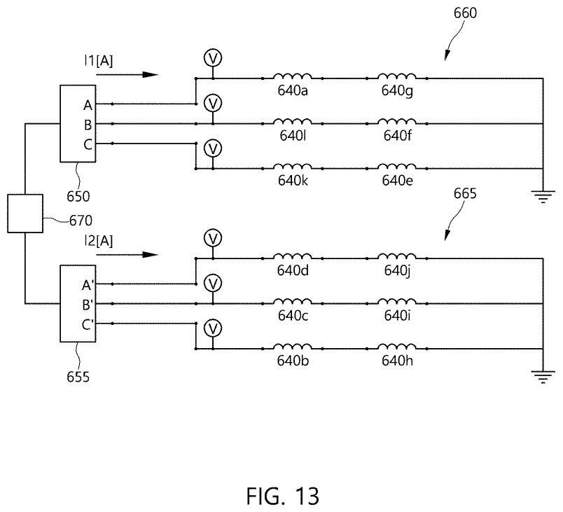

FIG. 12 is a cross-sectional view of a dual winding motor according to a sixth embodiment of the present disclosure, and FIG. 13 is an equivalent circuit diagram of the dual winding motor of FIG. 12 in a case in which coils are connected in series.

As shown in the drawing, a dual winding motor 600 according to the sixth embodiment of the present disclosure includes a stator 610 and a rotor 620 accommodated in the stator 610 and configured to be rotated due to a magnetic force generated from the stator 610.

In the sixth embodiment of the present disclosure, a shape of the stator 610 may be asymmetrical. That is, lengths of first, fifth, sixth, seventh, eleventh, and twelfth winding poles 615a, 615e, 615f, 615g, 615k, and 615l are smaller than those of second, third, fourth, eighth, ninth, and tenth winding poles 615b, 615c, 615d, 615h, 615i, and 615j.

In this case, winding protrusions 616 of each of the first to twelfth winding poles 615a to 615l are formed at predetermined intervals to form a substantially circular shape. Consequently, a shape of a core 611 which is a circumferential surface of the stator 610 may be configured such that protrusions 611a and 611c and concave portions 611b and 611d are alternately disposed.

In this case, the second, third, and fourth winding poles 615b, 615c, and 615d may be disposed in the first protrusion 611a, and the fifth, sixth, and seventh winding poles 615e, 615f, and 615g may be disposed in the first concave portion 611b. Similarly, the eighth, ninth, and tenth winding poles 615h, 615i, and 615j may be disposed in the second protrusion 611c, and the eleventh, twelfth, and first winding poles 615k, 615l, and 615g may be disposed in the second concave portion 611d.

First to twelfth coils 640a to 640l may be wound around the first to twelfth winding poles 615a to 615l.

In the sixth embodiment of the present disclosure, the first coil 640a and the seventh coil 640g opposite to the first coil 640a are connected in series or in parallel such that an A-phase current of the motor 600 may flow in the first coil 640a and the seventh coil 640g, and the twelfth coil 640l and the sixth coil 640f opposite to the twelfth coil 640l are connected in series or in parallel such that a B-phase current of the motor 600 may flow in the twelfth coil 640l and the sixth coil 640f. Similarly, the eleventh coil 640k and the fifth coil 640e opposite to the eleventh coil 640k are connected in series or in parallel such that a C-phase current of the motor 600 may flow in the eleventh coil 640k and the fifth coil 640e.

As described above, the first coil 640a, the seventh coil 640g, the twelfth coil 640l, the sixth coil 640f, the eleventh coil 640k, and the fifth coil 640e may constitute the first winding part 660.

Meanwhile, the fourth coil 640d and the tenth coil 640j opposite to the fourth coil 640d may be connected in series or in parallel such that an A′-phase current of the motor 600 may flow in the fourth coil 640d and the tenth coil 640j. In this case, the A′-phase current may serve as redundancy of the A-phase current. The third coil 640c and the ninth coil 640i opposite to the third coil 640c may be connected in series or in parallel such that a B′-phase current of the motor 600 may flow in the third coil 640c and the ninth coil 640i. Further, the second coil 640b and the eighth coil 640h opposite to the second coil 640b may be connected in series or in parallel such that a C′-phase current of the motor 600 may flow in the second coil 640b and the eighth coil 640h. Similarly, the B′-phase current may serve as redundancy of the B phase current, and the C′-phase current may serve as redundancy of the C-phase current.

As described above, the fourth coil 640d, the tenth coil 640j, the third coil 640c, the ninth coil 640i, the second coil 640b, and the eighth coil 640h may constitute the second winding part 665.

In the dual winding motor 600 having such a structure, the first winding part 660 may output a three-phase voltage using a current supplied from a first inverter 650 due to a serial connection between the first coil 640a and the seventh coil 640g, a serial connection between the twelfth coil 640l and the sixth coil 640f, and a serial connection between the eleventh coil 640k and the fifth coil 640e.

Further, a second winding part 665 which serves as redundancy of the first winding part 660 may output a three-phase voltage using a current supplied from a second inverter 655 due to a serial connection between the fourth coil 640d and the tenth coil 640j, a serial connection between the third coil 640c and the ninth coil 640i, and a serial connection between the second coil 640b and the eighth coil 640h.

In this case, the number of turns of the coils of the second winding part 665 may be twice the number of turns of the coils of the first winding part 660.

As in the conventional case, when the number of turns of the coils of the first winding part is equal to the number of turns of the coils of the second winding part and a failure occurs in one inverter due to heat generation, even though the other inverter can drive the motor, the other inverter should output a current that is twice a usual current such that normal operation is impossible due to the heat generation.

However, as in the sixth embodiment of the present disclosure, when the number of turns of the coils of the second winding part 665 is twice the number of turns of the coils of the first winding part 660, the controller 670 may control the second inverter 655, in normal operation, to allow the second winding part 665 to output a current that is half of a current of the first winding part 660. Even in a case in which a failure occurs in the first winding part 660 such as to not be driven, the controller 670 may control the second inverter 655 to allow the second winding part 665 to output a current that is the same as a usual current output to the first winding part 660.

Consequently, since the motor 600 may maintain the same torque as in the normal operation even when the second inverter 655 outputs the same current as usual, it is possible to drive the motor 600 as stably and consistently as when driving the motor 600 through the first and second windings 660 and 665.

In accordance with the present disclosure, a heating value of each coil is varied such that there is an effect which is capable of implementing redundancy even when overload occurs.

Further, in accordance with the present disclosure, even when one inverter is broken due to overload, there is an effect which is capable of driving a motor stably and consistently through the other inverter.

As discussed in the foregoing, although all the elements forming the exemplary embodiments of the present disclosure are combined into one or operated as one element, the present disclosure is not limited thereto. That is, all the elements may be selectively combined or operated if within an object scope of the present disclosure. Furthermore, it will be understood that the terms “includes” and/or “including,” “forming” and/or “formed” when used in this specification, specify the presence of stated features, regions, integers, steps, operations, elements, and/or components, but do not preclude the presence or addition of one or more other features, regions, integers, steps, operations, elements, components, and/or groups thereof.

What is claimed is:

1. A dual winding motor comprising:
a stator; and
a rotor accommodated in the stator and configured to be rotated by the stator,
wherein the stator includes:
a core configured to accommodate the rotor in a central portion thereof;
a plurality of winding poles configured to protrude from the core toward the rotor and around which coils are wound;
a plurality of first coils wound around some of the plurality of winding poles and configured to constitute a first winding part through which a three-phase current flows; and
a plurality of second coils wound around the remaining poles among the plurality of winding poles and configured to constitute a redundancy part of the first winding part,
wherein the first coil is asymmetrical with the second coil.

2. The dual winding motor of claim 1, wherein the number of turns of the second coil is larger than that of the first coil.

3. The dual winding motor of claim 1, wherein the number of turns of the second coil is substantially twice that of the first coil.

4. The dual winding motor of claim 1, wherein a diameter of the second coil is smaller than that of the first coil.

5. The dual winding motor of claim 1, wherein:
a diameter of the second coil is smaller than that of the first coil; and
the number of turns of the second coil is larger than that of the first coil.

6. The dual winding motor of claim 1, wherein:
a diameter of the second coil is smaller than that of the first coil; and
the number of turns of the second coil is smaller than that of the first coil.

7. The dual winding motor of claim 1, wherein a magnitude of a current supplied to the first coil is different from that of a current supplied to the second coil.

8. A dual winding motor comprising:
a stator; and
a rotor accommodated in the stator and configured to be rotated by the stator,
wherein the stator includes:
a core configured to accommodate the rotor in a central portion thereof;
a plurality of winding poles configured to protrude from the core toward the rotor and around which coils are wound;
a plurality of first coils wound around a plurality of first winding poles which are some of the plurality of winding poles and configured to constitute a first winding part through which a three-phase current flows; and
a plurality of second coils wound around a plurality of second winding poles which are the remaining poles among the plurality of winding poles and configured to constitute a redundancy part of the first winding part,
wherein the first winding pole is asymmetrical with the second winding pole.

9. The dual winding motor of claim 8, wherein a length of the first winding pole is smaller than the of the second winding pole.

10. The dual winding motor of claim 9, wherein the first winding pole and the second winding pole are alternately disposed.

11. The dual winding motor of claim 9, wherein the first winding pole is disposed at one side of the core, and the second winding pole is disposed at the other side of the core.

12. The dual winding motor of claim 9, wherein some of the plurality of first winding poles and some of the plurality of second winding poles are alternately disposed.

13. The dual winding motor of claim 9, wherein the number of turns of the second coil is larger than that of the first coil.

14. The dual winding motor of claim 9, wherein the number of turns of the second coil is substantially twice that of the first coil.

15. The dual winding motor of claim 9, wherein a magnitude of a current supplied to the first coil is different from that of a current supplied to the second coil.
